(19) United States
(12) Patent Application Publication
(10) Pub. No.: US 2008/0169389 A1
(43) Pub. Date: Jul. 17, 2008

(54) COLLAPSIBLE STAND

(76) Inventor: J. Lyle Hill, Smithfield, UT (US)

Correspondence Address: KIRTON & MCCONKIE;A PROFESSIONAL CORPORATION, ATTORNEYS AT LAW, 1800 EAGLE GATE TOWER, 60 EAST SOUTH TEMPLE STREET, SALT LAKE CITY, UT, 84111, US

(21) Appl. No.: 11/622,884

(22) Filed: Jan. 12, 2007

(51) Int. Cl. F16M 11/22

(52) U.S. Cl. 248/166

(57) ABSTRACT

A collapsible stand with at legs connected to a pivot junction via extension supports which may be retracted or expanded in relation to the pivot junction to create a variety of variety of radii to accommodate different objects such as water coolers, the object either resting on the extension supports or on accessories such as a shelf which may be selectively coupled to the stand.

### BACKGROUND

1. Related Applications

The present invention relates to a stand for supporting objects and more particularly, to a stand that is capable of easy collapsible storage and transport, and that can expand to support various sized objects.

2. Background and Related Art

It is often desirable to support an object above a surface. For instance, if the object is a water container, a user may want to store it at a level that is easy to use and access. Placing the container on a stand provides such optimal access.

Unfortunately, currently available stands used to support objects have many drawbacks. For instance, many stands do not work on uneven ground or surfaces because they have four legs. Moreover, many stands are not readily storable and transportable because they are cumbersome to collapse, or they do not collapse into a flat enough position to enable compact storage. Additionally, many stands are made to accommodate one size container or object. Specifically, in the aforementioned example, most water stands hold only one size water container.

A need, therefore, exists for a stand that serves as a suitable adjunct to any place a user desires to support an object above either an even or uneven surface. And, further, a need exists for a stand that is capable of flatly collapsing for easy transport and storage and that can accommodate various sized objects.

### SUMMARY AND OBJECTS OF THE INVENTION

Some embodiments of the present invention provide an apparatus and method for supporting an object, and more specifically, an apparatus and method that optimally collapses, easily transports, and retracts and expands to accommodate various-sized objects.

The preferred embodiment of the present invention involves a stand that supports objects, such as containers, water containers, and the like. Each embodiment comprises a plurality of legs about a pivot juncture, where each leg can be retracted toward or expanded away from the pivot juncture to receive different sized objects. One embodiment comprises three legs, each of which has an upper and lower member protruding from the legs. These upper and lower members connect to two pivotal junctures, each of which is comprised of upper, middle and lower flanges. Each of the flanges has a first end with an orifice for receiving a pin and a second end. The pin, when entered through the orifices of each of the flanges, pivotally connects the flanges together. In this embodiment, the two pivotal junctures include a top pivotal juncture that connects to the upper member on each of the legs, and a bottom pivotal juncture that connects to the lower members of each of the legs. The connection made between the members of the legs and the flanges of the pivotal juncture, forms the stand and creates an opening or space for receiving an object. Specifically, the object rests above the upper member and the top pivotal juncture. Even more specifically, once the legs and their corresponding members are connected to the pivotal junctures, via the pivotal juncture's flanges, the desired object or container rests on top of a Y-shaped region formed (or a space created above), by the connection between the top pivotal juncture and the upper members of the legs. Additionally, in this embodiment, each of the members has an elongated groove that runs parallel with the member. The groove secures the connection between the legs and the pivotal juncture by receiving within the groove, a nodule located on each of the members. In other words, the nodule is located on each of flanges of the pivotal juncture. This nodule-and-groove combination enables slidable communication and connection between the pivotal junctures and the legs, which ultimately form a location above the top pivotal juncture and the upper members of the legs for holding the object. Further, the slidable connection causes the space to retract and expand, which in turn, accommodates various sizes of objects.

Another way to describe the function of the nodule and groove feature is to explain that it is the extension and retraction of the flanges, which causes the legs of the stand to be moved away from or closer to the pivot juncture. This permits the stand to support objects of various sizes. In other words, the nodule on the flange serves as a stopping mechanism that allows the stand to expand to a maximum size, to contract to a minimum size, or to be adjusted to any position therebetween. As further illustration, the nodule being slid within the groove toward the pivot juncture permits the stand to hold a smaller object or container, whereas in contrast, when the nodule is fully extended the stand holds a larger object or container.

The present invention also contemplates embodiments as few as two legs and/or utilizing a singular pivot juncture.

In some embodiments of the present invention, the stand may comprise one or more appliance rings, used for storing a garbage bag, a water cup tray, a drip bowl, a potted plant, sports equipment, balls, and the like. This feature need not necessarily be a ring, but may comprise any shape suitable for storage near the space for holding the object which ring may be located along the leg.

In one embodiment the present invention, the appliance ring is connected to the stand with one or more downward facing U-shaped pins, which fits into one or more receivers mounted along the legs. The “U” shape of the pins permits the appliance ring to be connected to the stand when the stand is expanded or contracted to accommodate different size objects. For example, when the legs, and their integrally attached members, are closer toward the pivot juncture, the appliance ring is connected to the stand using one set of prongs of the U-shaped pins. In contrast, when the legs, and their integrally attached members, are furthest from the pivot juncture (i.e., in a fully expanded position), the appliance ring is connected to the stand by placing another set of prongs of the U-shaped pins into the receivers on the legs of the stand.

Accordingly, it is an object of some embodiments of the present invention to provide a method and apparatus for supporting an object above an even or uneven surface to enable easy access to the contents of the object being stored.

It is another object of some embodiments of the present invention to provide a method and apparatus for supporting an object that is collapsible and capable of easy storage and transport.

Another object of some embodiments of the present invention is to provide a method and apparatus for supporting an object that retracts and expands to accommodate various sized objects.

Yet another object of some embodiments of the present invention is to provide a method and apparatus for supporting an object that can support containers and various other accessories.

These and other objects of the present invention will become more fully apparent from the following description, drawings, and claims. Other objects will likewise become apparent from the practice of the invention as set forth hereafter.

### BRIEF DESCRIPTION OF THE DRAWINGS

The foregoing and other objects and features of the present invention will become more fully apparent from the accompanying drawings when considered in conjunction with the following description and appended claims. Although the drawings depict only typical embodiments of the invention and are thus, not to be deemed limiting of the invention's scope, the accompanying drawings help explain the invention in added detail.

FIG. 1 depicts one view of the preferred embodiment.

FIG. 2 depicts another view of the present invention without the appliance ring.

FIG. 3 depicts a view of the preferred embodiment supporting a water container.

FIG. 4 depicts the present invention in its collapsed and ready-for-transport form.

FIG. 5(a) depicts one embodiment of the legs.

FIG. 5(b) depicts another embodiment of the legs.

FIG. 5(c) depicts yet another embodiment of the legs.

FIG. 6 is a view of the stand using the embodiment of the legs depicted in FIG. 5(b).

FIG. 7 is a view of an embodiment of the stand having four legs.

FIG. 8 is a close-up view of the top pivot juncture in one embodiment of the present invention.

FIG. 9 is an enlarged view of the top pivot juncture. The bottom pivot juncture is shown beneath the top pivot juncture.

FIG. 10(a) is a view of the pivot juncture as it is being drawn together to collapse the stand and store.

FIG. 10 (b) depicts a pivot juncture with the upper, middle and lower flange unconnected and separated (i.e., without the pin).

FIG. 10 (c) depicts another view, which is similar to FIG. 8(a), showing the pivot juncture as it is about to align the upper, middle and lower flanges, and consequently, about to form the collapsed stand.

FIG. 10 (d) depicts a view of the upper, middle and lower flange separated and the pin that enters the orifices found on each of the upper, middle and lower flanges.

FIG. 10 (e) shows a pivot juncture in the position it would take if the stand were collapsed and ready for transport or storage.

FIG. 11(a) shows another embodiment of the present invention, and specifically, another embodiment of the pivot juncture.

FIG. 11(b) shows yet another embodiment of the pivot juncture.

FIG. 12 shows one embodiment of the U-shaped pin that connects the appliance ring to the legs of the stand.

### DETAILED DESCRIPTION OF THE INVENTION

It is emphasized that the present invention, as illustrated in the figures and description herein, can be embodied in other forms. Thus, neither the drawings nor the following more detailed description of the various embodiments of the system and method of the present invention limit the scope of the invention. The drawings and detailed description are merely representative of examples of embodiments of the invention; the substantive scope of the present invention is limited only by the appended claims recited to describe the many embodiments. The various embodiments of the invention will best be understood by reference to the drawings, wherein like elements are designated by like alphanumeric character throughout.

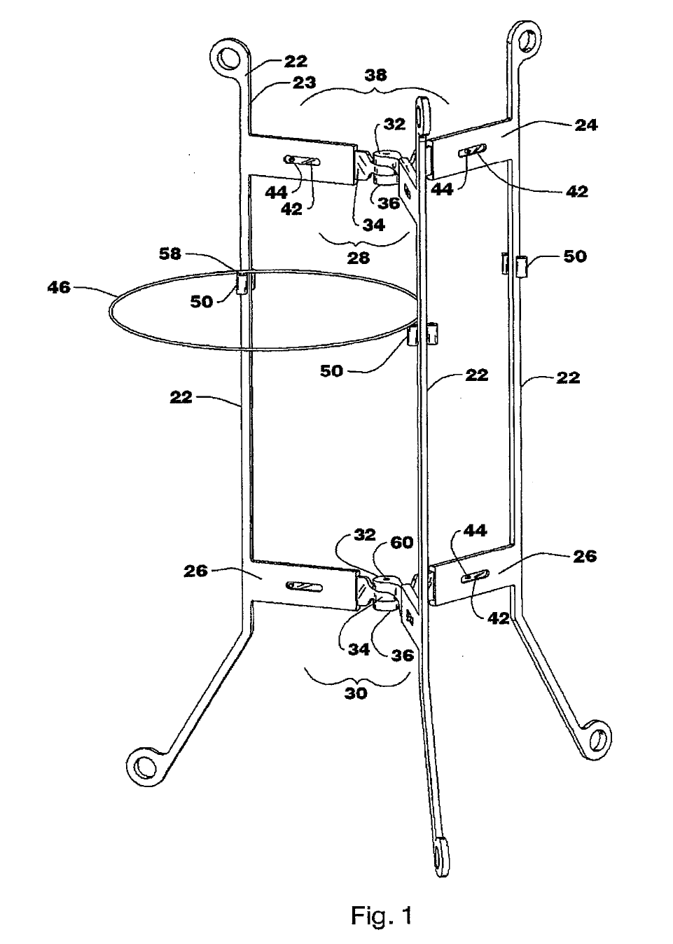

With reference now to the accompanying drawing, FIG. 1 depicts one view of one embodiment. In this view, the stand 20 is shown in a perspective view in its entirety. The legs 22 each have an upper member 24 and a lower member 26 protruding and integrally connected to the legs 22). Upper members 24 and lower members 26 connect to respectively a top pivotal juncture 28 and a bottom pivotal juncture 30. Leg 22 has a lateral support portion 23 above upper member 24. Each pivot juncture (28, 30) is further comprised of a flange for each leg. In FIGS. 1-4, 8-10, a three-flange configuration is illustrated showing upper flange 32, a middle flange 34 and a lower flange 36. The upper, middle and lower flange (32, 34, 36) each have a first end with an orifice 56 and a second end 58. A pin 60 is received within each of the orifices 56 to pivotally position the upper, middle and lower flanges (32, 34, 36) relative to each other.

Thus, the means for the legs 22 to rotate around a pivot juncture (28, 30) comprises flanges (32, 34, 36) and the pin 60 specified above.

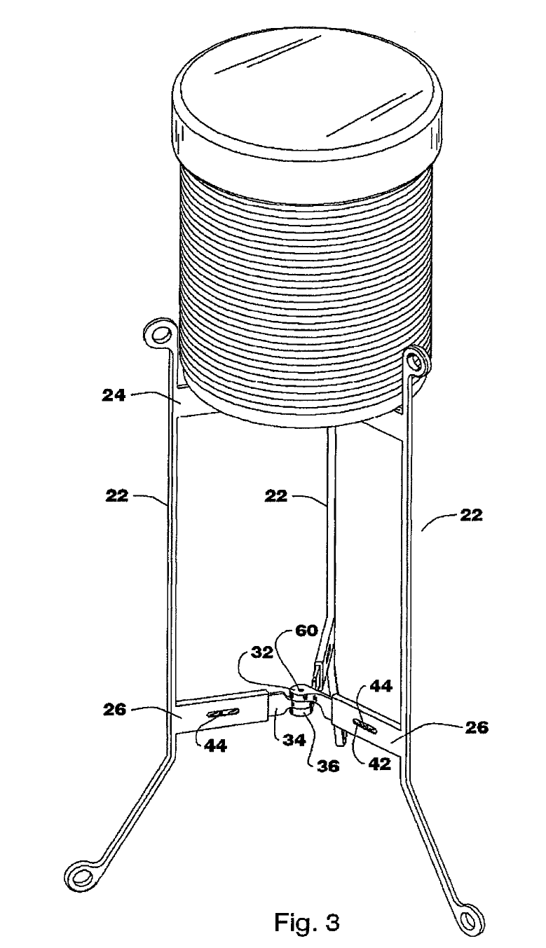

The top pivotal juncture 28 connects to upper members 24. The bottom pivotal juncture 30 connects to lower members 26. In further detail, the members (24, 26) connect with the flanges (32, 34, 36) to make the connection between the pivotal junctures (28, 30) and the legs 22. This connection of legs 22 to pivot juncture(s) (28, 30) forms the stand, and when positioned radially, creates a space 38 within lateral support members 23 for receiving an object 40 (shown for example in FIG. 3). The object 40, (shown for example in FIG. 3), rests above the members (32, 34, 36) on each of the legs 22 and above the pivotal juncture 28. Thus, once the legs 22 and their corresponding integrally connected members (24, 26) are connected to the pivotal junctures (28, 30) (via the pivotal junctures' (28, 30) flanges (32, 34, 36)), the object is placed in space 38 between lateral support members 23 created above the pivotal juncture (28) and the leg members. If one were to take a bird's eye view of the top of the stand 20 downward, space 38 is under-girded by a Y-shaped configuration support.

Additionally, each of the members (24, 26) acts to maintain the adjacent positioning has an elongated groove 42 along members (24, 26). In one embodiment, members 24 and 26 comprise an open channel to receive the seconds ends 58 of flanges 32, 34, and 36. The groove 42 secures the legs 22 and the pivotal junctures (28, 30) by receiving within the groove 42, a nodule 44 disposed on the flanges (32, 34, 36). The nodule-in-groove configuration also enables selectively slidable movement of The flanges 32, 34, and 36 with the channel of members 24 and 26. This slidable connection enables space 38 between supports 23 to expand and contract to accommodate objects of different sizes within lateral support portions 23 defining space 38. Moreover, the slidable connection enables the space 38 to retract and expand depending on the size of the object 40 to be supported. In essence, the nodule 44 and groove 42 configuration enables the flanges (32, 34, 36) held within the members (24, 26) to selectively and slidably extend and retract, thereby causing the legs 22 of the stand to move away from or closer to the pivot juncture (28, 30). Put another say, the nodule 44 on the flanges (32, 34, 36) serves as a stopping mechanism that allows the stand 20 to expand to a maximum size, to contract to a minimum size, or to be adjusted to any position therebetween. For example, the nodule 44 being slid within the groove 42 toward the pivot junctures (28, 30) could permit the stand 20 to hold a five gallon water container 40, whereas in contrast, when the nodule 44 is fully extended the stand 20 could hold a ten gallon water container 40. Thus, means for adjustably connecting the legs 22 to the pivot juncture (28, 60) such that the legs 22 are capable of selectively moving away from the pivot juncture (28, 30) and closer to the pivot juncture (28, 30) to accommodate supporting various-sized objects 40, is disclosed by the nodule and groove description provided above.

FIG. 1 further depicts one embodiment of the present invention with an appliance ring 46. This ring 46, which need not necessarily be a ring, serves to store garbage bags, accessories, water trays carrying cups, drip bowls, potted plants, sports equipment, balls, and the like. The ring 46 is located at some point along leg 22. The ring 46 is connected to the stand 20 with one or more downward facing (i.e., upside down) U-shaped pins 48. Pin 48 could have three or more forwardly extending prongs. These U-shaped pins 48 fit into one or more receivers 50 that are connected to the legs 22. The “U” shape of the U-shaped pins 48 permits the ring 46 to be connected to the stand 20 when the stand 20 is expanded or contracted to accommodate different sizes of objects 40. For example, when the legs 22 and their integrally attached members 24, 26, are closer toward the pivot junctures 28 and 30, the ring 46 is connected to the stand 20 using one set of prongs 52. In contrast, when the legs 22, and their integrally attached members 24, 26, are extended away from the pivot juncture (28 or 30), the appliance ring 46 is connected to the stand 20 by placing another set of prongs 54, into the receivers 50.

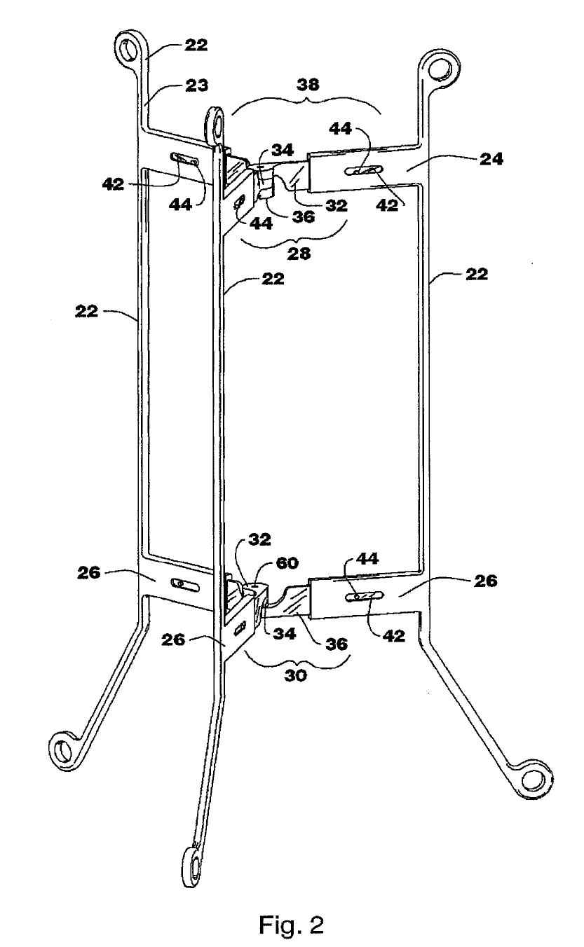

FIG. 2 depicts another view of the present invention without the appliance ring. In this figure, the upper, middle and lower flange (32, 34, 36, respectively) are easily viewable.

FIG. 3 depicts a view of one preferred embodiment supporting a water container 40.

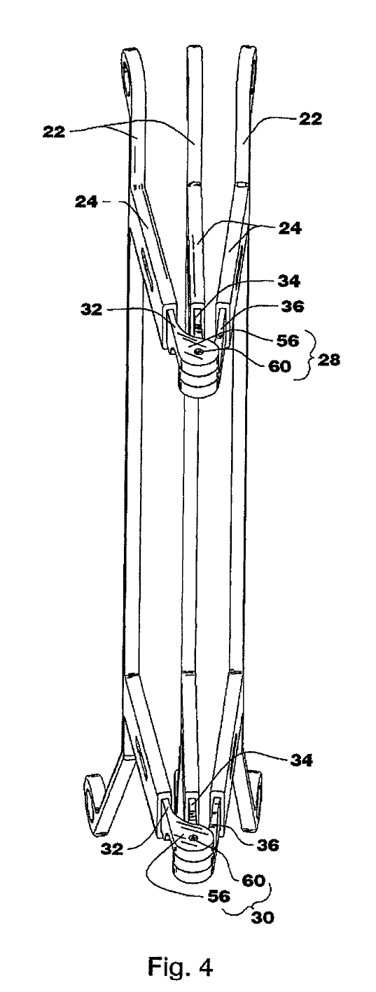

FIG. 4 depicts one embodiment in its collapsed and ready-for-transport position. Here, the flanges (32, 34, 36) of the pivotal juncture 28 are aligned substantially parallel and side-by-side with each other. The same is true for a lower pivot juncture 30 and lower leg members 26. FIG. 4 illustrates one embodiment of the pivotal junctures (28, 30) and how each of the flanges (32, 34, 36) has a first end with an orifice 56, which pivots about pin 60. FIG. 4 illustrates that one or more flanges are attached at the first end such that the axis of the flanges does not intersect orifice 56. In this way, the flanges will lie substantially parallel and side-by-side in the collapsed state.

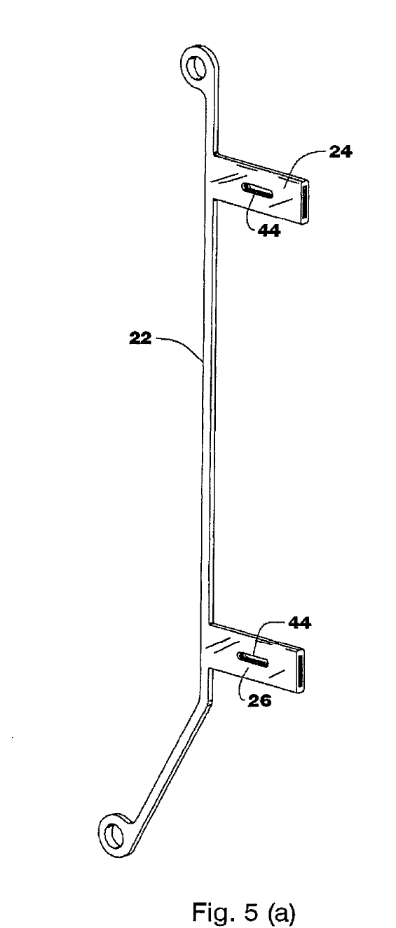

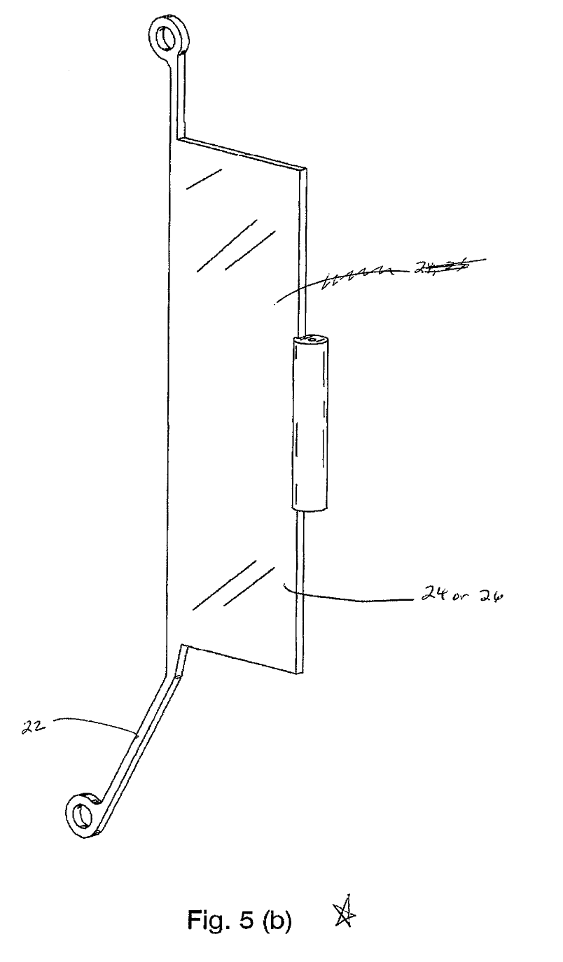

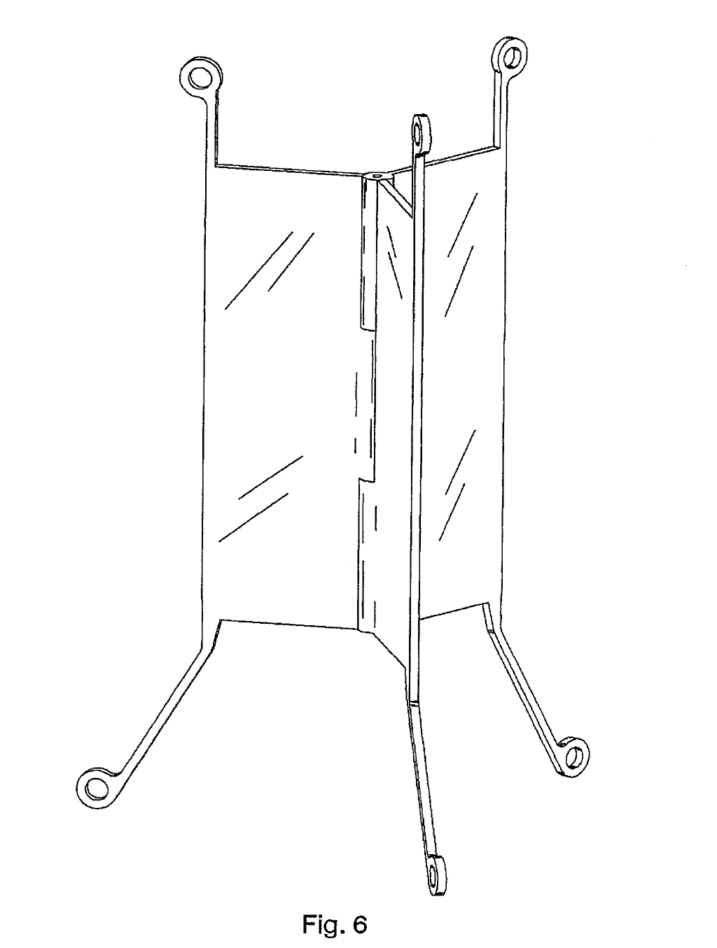

FIG. 5(a) is a view of one embodiment illustrating a configuration of leg 22. This figure depicts the upper member 24 and the lower member 26 as they are unattached to the flanges (32, 34, 36). It illustrates the grooves 42 on each of the members (24, 26).

FIG. 5(b) is a view of another embodiment of the legs. In this embodiment, there is a single member (24 or 26) protruding from the leg 22, rather than upper and lower members (24, 26) as illustrated in other embodiments. In this embodiment, one or more grooves 42 can be utilized to join the leg member to a pivotal structure. This embodiment enables the stand to only have one pivotal juncture, but the single vertical leg 22 branches out into one or more support members 24A and/or 24B.

FIG. 6 shows an embodiment of the stand 20 as it would appear with legs 22 as depicted in FIG. 5(b). In this embodiment, a single member (24 or 26) protrudes from each of the legs 22, rather than the upper and lower members (24, 26) as illustrated in other figures.

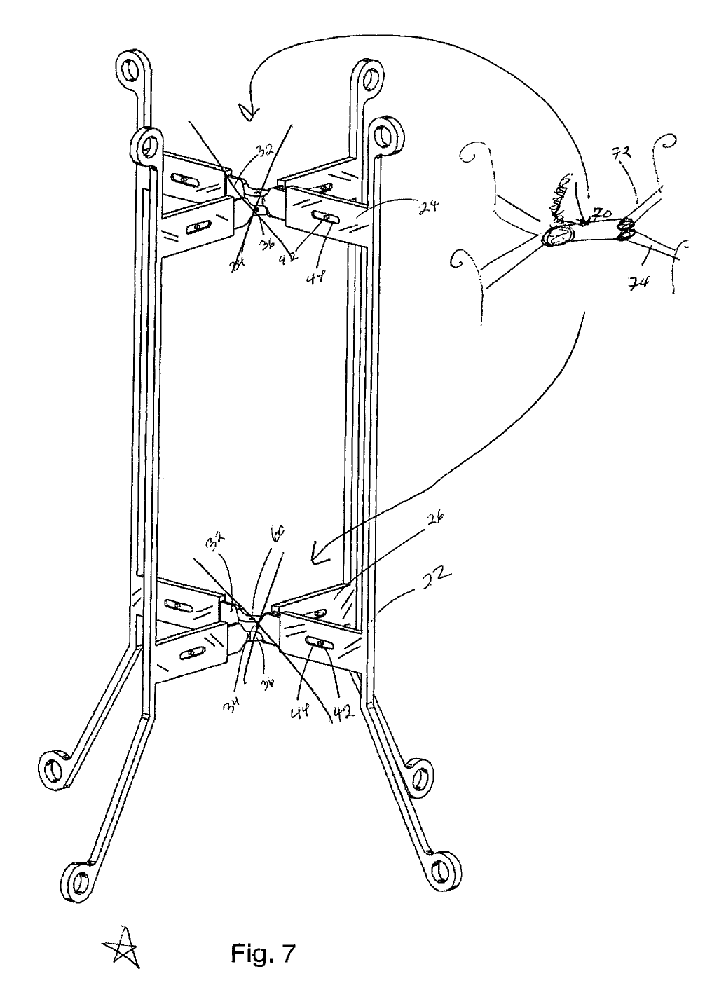

FIG. 7 is a view of an embodiment of the stand 20 having three or four legs. In this embodiment, the flanges (32, 34, 36) are the same as explained above, however, one or more of the flanges (either the upper, middle or lower) further divides to attach an additional leg. Specifically, one or more of the flanges 70 separates into two more flanges (72, 74), each of which is capable of receiving a member (24, 26) from a leg 22. This embodiment permits three or more legs with still one pivotal juncture. It is contemplated that the embodiment shown in FIG. 7 could have one or more pivotal junctures. For example, the point at which flange 70 separates into flanges 72 and 74 could be configured with another pivotal juncture, which is similar in structure to the top and bottom pivotal junctures explained above.

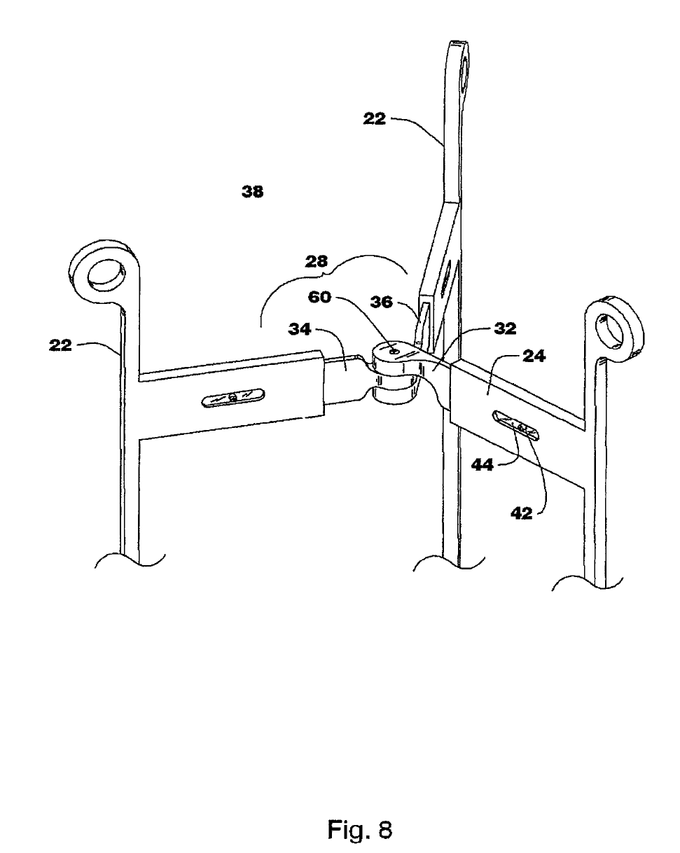

FIG. 8 illustrates one configuration of a pivot juncture 28, which is a close-up view of the top pivot juncture 28. Specifically, FIG. 8 shows the nodules 44 of the flange protruding through groove 42. This figure more clearly shows the nodules 44 as it exists within the grooves 43. It also illustrates the space 38 created within lateral support portions 23 when the stand 20 is in ready position for receiving an object 40.

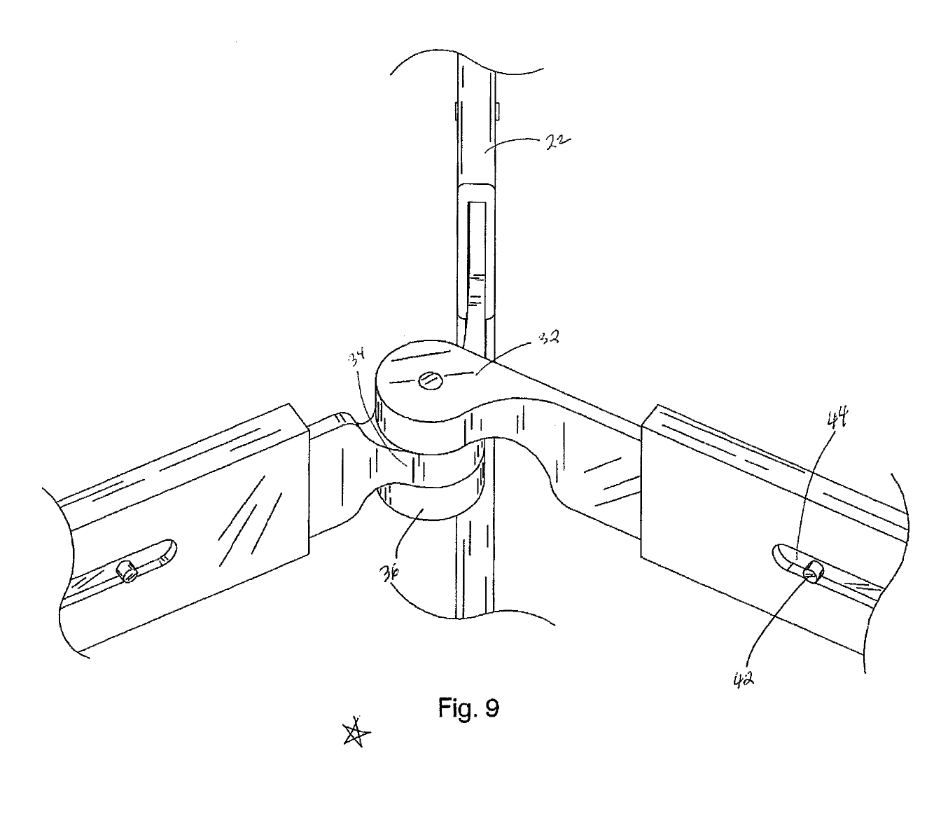

FIG. 9 is an enlarged view of the top pivot juncture 28. The pin 60 is readily viewable as it is within the orifices 58 of each of the upper, middle and lower flanges (32, 34, 36). The bottom pivot juncture 30 is shown beneath the top pivot juncture 28. That is, FIG. 9 illustrates one embodiment of flanges and the relative configuration of the flange members about orifice 56 that permit the stand components to fold flat against each other.

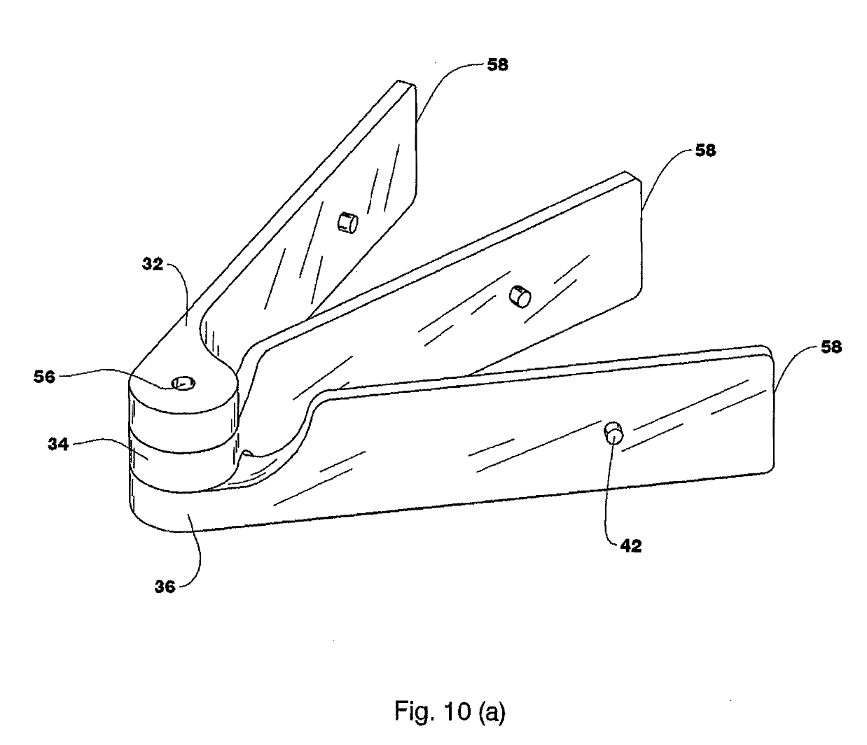

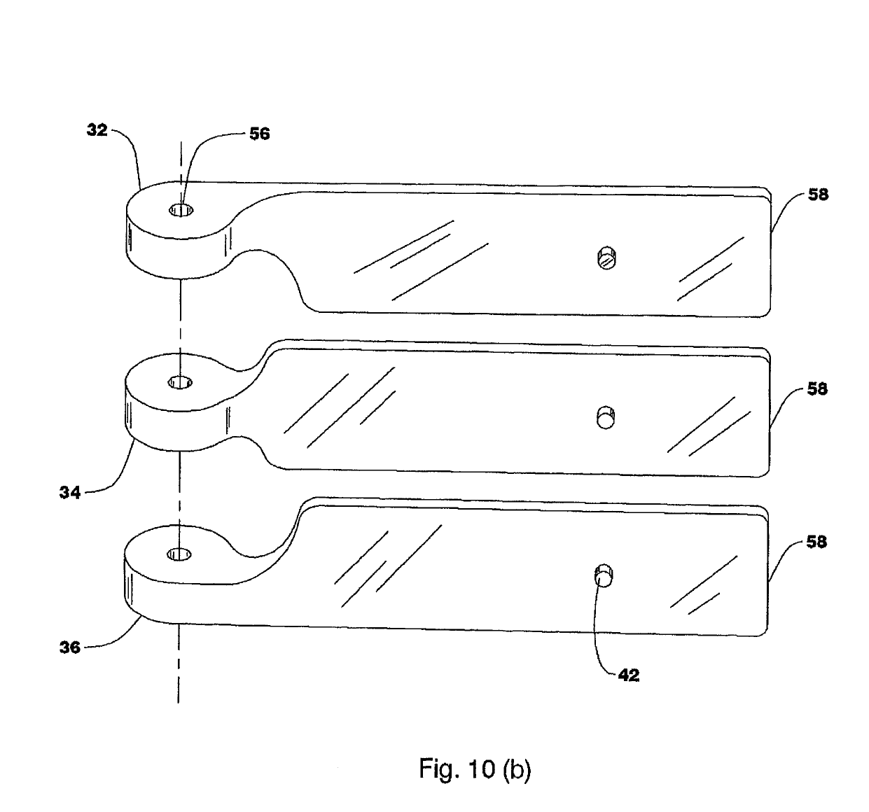

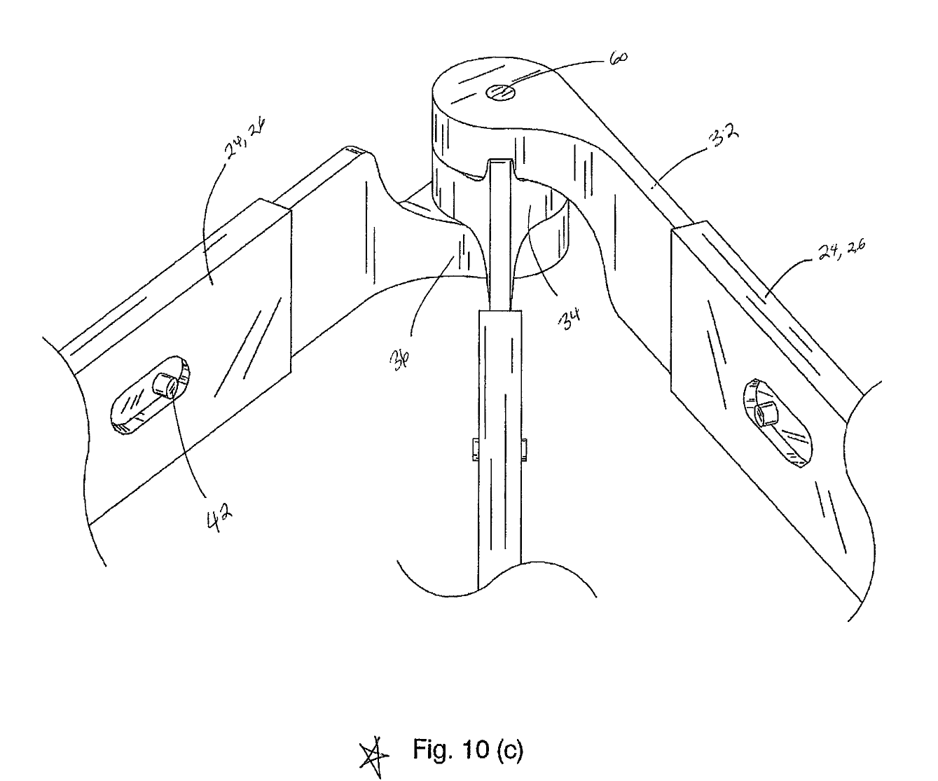

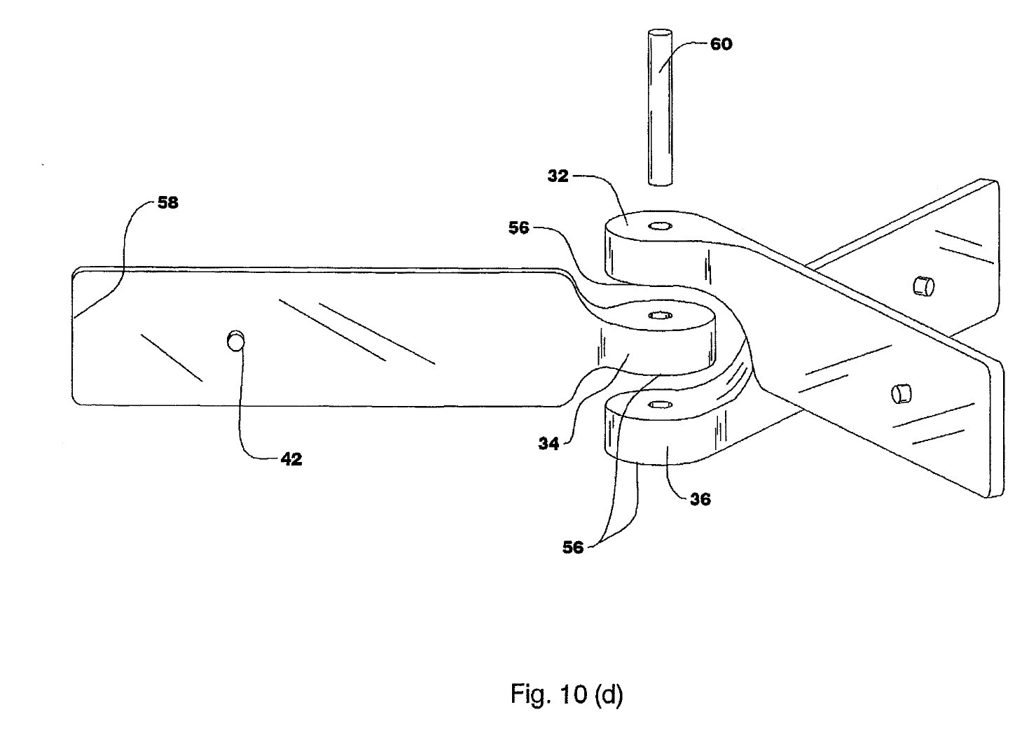

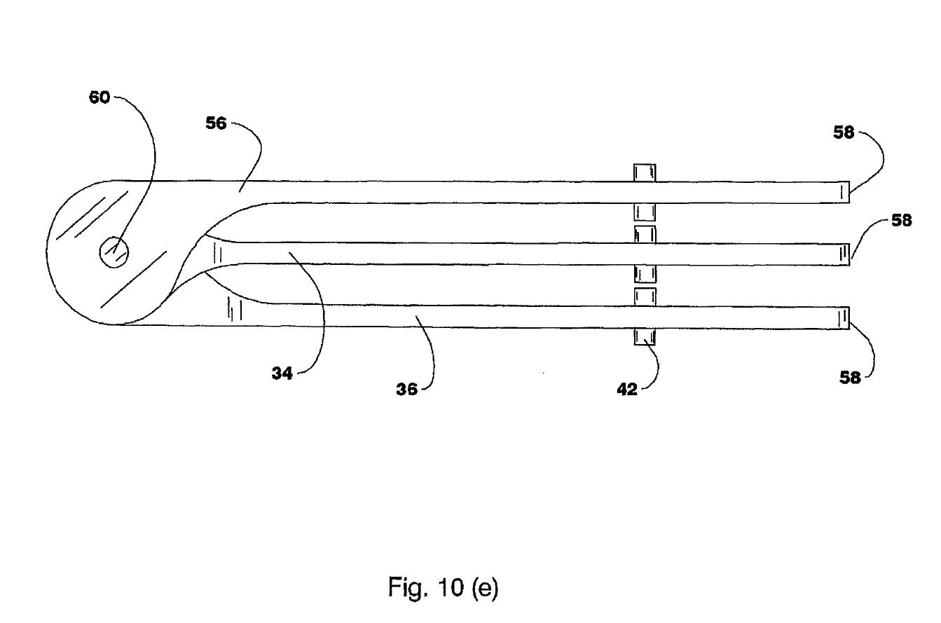

FIG. 10(a) is a view of a pivot juncture (28, 30) as it is being drawn together to collapse the stand 20 for storage or transport.

FIG. 10(b) depicts a pivot juncture (28, 30) with the upper, middle and lower flange (32, 34, 36) unconnected and separated (i.e., without the pin 60).

FIG. 10 (c) depicts another view, similar to FIG. 8(a), showing a configuration of the flanges and the pivot juncture (28 or 30), which permits the flanges to fold substantially flat or parallel, and side-by-side, and consequently, collapse the stand 20.

FIG. 10(d) depicts another view of the upper, middle and lower flange (32, 34, 36) separated and the pin 60 that enters the orifices 58 found on each of the upper, middle and lower flanges (32, 34, 36).

FIG. 10(e) shows a pivot juncture (28, 30) in the position it would be in if the stand 20 were collapsed and ready for transport or storage. In this figure, the upper, middle and lower flanges (32, 34, 36) are not shown within the members (24, 26).

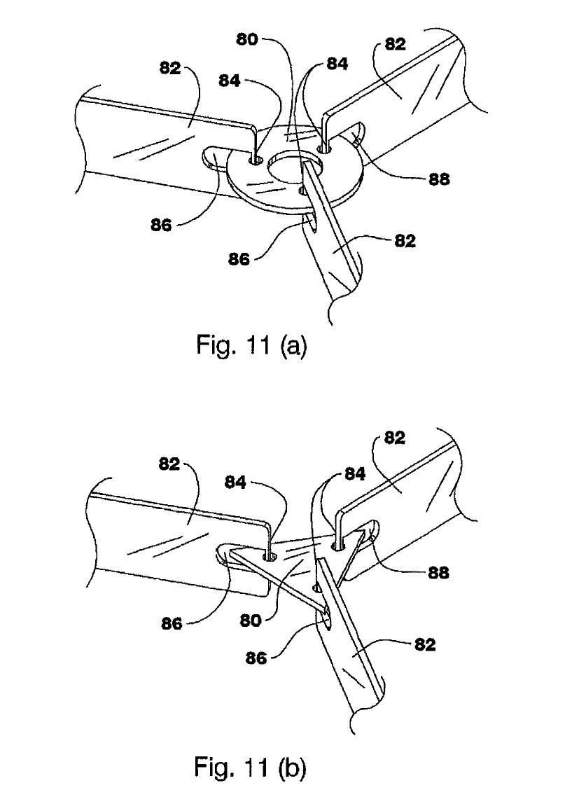

FIGS. 11 (a) and 11(b) show other embodiments of the pivot juncture (28, 30). Specifically, in FIG. 11(a) the pivot juncture comprises a single disc 80, having pin-flanges 82 connected via rotatable pins 84 connected to each of the pin-based flanges 82. The pin-based flanges 82 are connected to the disc 80 in a way to allow rotation of flange 82 around the disc 80 so that when the stand 20 is collapsed, the pin-based flanges 82 align substantially flat and parallel with one another, in a side-by-side arrangement. Specifically, each of the pin-based flanges 82 has a slot 86 that the disc 80 is positioned within so as to enable rotation of the pin-based flanges 82 around the disc 80. All slots 86 may be of sufficient size to permit all flanges 82 to rotate to a side-by-side position. Or, one or more slots 86 may be larger than the other slots 86 because one the pin-based flanges 82 must move around the disc 80 a greater distance to reach the side-by-side, collapsed position.

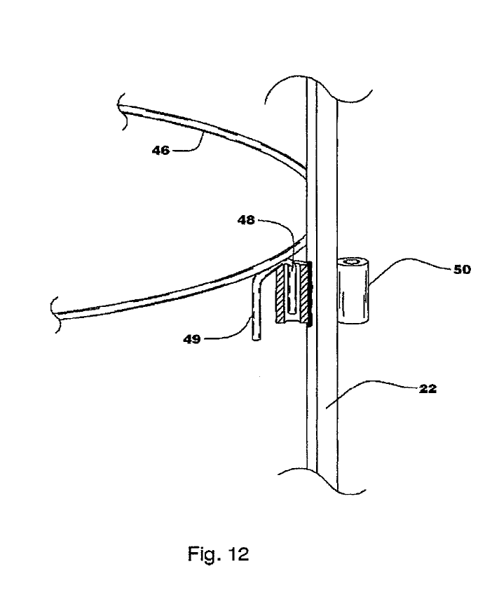

Finally, FIG. 12 shows one embodiment of the present invention having the appliance ring in enlarged view. In this figure, the pin 48 that connects appliance ring 46 to legs 22 of stand 20. The ring 46 is removably connected to the stand 20 via the downward facing prongs 52 (i.e., upside down) of pin 48. Again, the prongs 49, 52 U-shaped pins 48 fit into one or more receivers 50 that are integrally connected to the legs 22. The prongs 49 of pins 48 permits the ring 46 to be selectively connected to the stand 20 when the stand 20 is expanded or contracted to accommodate different sizes of objects 40. For example, when the legs 22 and their integrally attached members 24, 26, are closer toward the pivot junctures 28 and 30, the ring 46 is connected to the stand 20 using one set of prongs 52 of pin 48. In contrast, when the legs 22, and their integrally attached members 24, 26, are extended away from the pivot junctures (28, 30) (that is, in a fully expanded position), the appliance ring 46 is connected to the stand 20 by placing another set of prongs 54 pins 48 into receivers 50. Pin 48 could have three or more prongs to accommodate intermediate extensions of the legs from one another.

What is claimed is:

1. An apparatus for supporting an object, comprising:
a plurality of legs;
a pivot juncture, wherein each leg may be selectively retracted toward or expanded away from the pivot juncture to receive different sized objects above the pivot juncture.

2. An apparatus as in claim 1, wherein the pivot juncture further comprises:
an outwardly extending flange corresponding to each leg wherein each leg comprises an inwardly extending member; and
wherein the leg members mate with the corresponding flange.

3. An apparatus as in claim 2, wherein each flange comprises a nodule and each leg member comprises an opening such that the nodule is received within the groove located on each of the members, so that slidable connection between the legs and the flange is possible.

4. An apparatus as in claim 2, wherein each of the flanges further comprises:
a first end with an orifice and a second end; and
a pin that is disposed within the orifices so that pivotal rotation of the flanges about the pin is possible and further enables the flanges to align with each other in a side by side arrangement such that the stand can collapse flatly.

5. A stand for supporting an object comprising:
a plurality of legs, wherein each of the legs comprises;
a member, integrally connected to and extending from each of the legs;
a groove located on each of the members;
a pivot juncture comprising;
a plurality of flanges corresponding to each leg member, each flange having a first end with an orifice and a second end;
a pin disposed in the orifices of the flanges to permit the flanges to pivot about the pin such that when pivoted about the pin, the flanges are capable of being radially positioned or substantially parallel and side-by-side;
a nodule on the flange, wherein the nodule is received within the groove of each of the members such that the legs and the pivot juncture are joined together and are in slidable communication such that the stand is retractable and expandable as the nodules move back and forth with the groove.

6. A stand for supporting an object comprising:
three legs, wherein each of the leg comprises:
at least two members, an upper member and a lower member, integrally connected to and extending from each of the legs;
a groove located on each of the members;
a top pivot juncture and a bottom pivot juncture, wherein the top pivot juncture and the bottom pivot juncture each further comprise;
an upper flange having a first end with an orifice and a second end;
a middle flange having a first end with an orifice and a second end;
a lower flange having a first end with an orifice and a second end;
a nodule on each of the upper, middle and lower flanges, wherein the nodule is received within the groove of each of the members such that the legs and the flanges of the pivot juncture are joined together and are in slidable communication such that the stand is retractable and expandable as the nodule moves back and forth within the groove.
a pin that when held within the orifices of the upper, middle and lower flange, pivotally connects the upper, middle and lower flange such that when the upper, middle and lower flange are in a Y-shaped configuration, the stand is open and a space is created that is capable of receiving an object to support on top pivotal juncture, and when the upper, middle and lower flange are flat against each other, the stand is closed and ready for transport.

7. A method for supporting an object, comprising:
providing a stand comprised of:
at least three legs, wherein each of the leg comprises:
at least two members integrally connected to and extending from the leg, wherein the members comprise an upper member and a lower member;
a groove located on each of the members;
providing a top pivot juncture and a bottom pivot juncture, wherein each of the top pivot juncture and the bottom pivot juncture further comprise:
an upper flange having a first end with an orifice and a second end;
a middle flange having a first end with an orifice and a second end;
a lower flange having a first end with an orifice and a second end;
a nodule on each of the upper, middle and lower flange, wherein the nodule is received within the groove of each of said the member such that the legs and the flanges of the pivot juncture are joined together and are in slidable communication such that the stand is retractable and expandable as the nodule moves back and forth within the groove; and
a pin that when held within the orifices of the upper, middle and lower flange, pivotally connects the upper, middle and lower flange such that when the upper, middle and lower flange are in a Y-shaped configuration, a space is formed and capable of receiving an object to support on the upper section of the top pivot juncture, and when the upper, middle and lower flange are flat against each other, the stand is closed and ready for transport.

8. A method for supporting an object, comprising:
providing a stand having:
a plurality of legs, wherein each of the leg comprises:
a member integrally connected to and extending from the leg, wherein the member comprises;
a groove located on each of the members;
providing a pivot juncture further comprising:
a flange having a first end with an orifice and a second end;
a nodule on the flange, wherein the nodule is received within the groove of each of the member such that the legs and flanges of the pivot juncture are joined together and in slidable communication, such that the stand is retractable and expandable as the nodule moves back and forth within the groove; and
a pin disposed within the orifices of flange, which pivotally connects the flange such that when the flange is in a Y-shaped configuration, a space is formed, which is capable of receiving an object to support on the pivot juncture.

9. A method as in claim 8, further comprising:
Providing a plurality of flanges having a first end with an orifice and a second end such that when the plurality of flanges are aligned in a side-by-side arrangement, the stand is collapsed and easy to transport.

10. A method for supporting an object, comprising:
Providing a stand having at least three legs, a top pivot juncture and a bottom pivot juncture, each of the pivot junctures further comprising an upper flange, a middle flange and a lower flange, wherein each flange has a nodule protruding perpendicularly from each of the flanges;
Providing an upper member and a lower member on each of the at least three legs, wherein each of the members has a groove for receiving the nodules of each of the flanges such that slidable connection and communication is made possible between the legs and the flanges of the pivot junctures, and a space is formed for receiving a container on top of the top pivot juncture.

11. A method as described in claim 3, wherein the space is capable of decreasing and increasing in size to accommodate different sizes of the objects.

12. A method as described in claim 3, wherein the upper, middle and lower flanges are capable of aligning flat with each other, such that the stand is collapsible and easily transported.

13. An apparatus for supporting an object, comprising:
a plurality of legs;
a means for plurality of legs to rotate around a pivot juncture; and a
a means for connecting the legs to the pivot juncture such that a space is created above the pivot juncture and in a way that the legs are selectively capable of moving away from the pivot juncture and closer to the pivot juncture so as to support various-sized objects.
